(19) United States
(12) Patent Application Publication
(10) Pub. No.: US 2006/0059747 A1
(43) Pub. Date: Mar. 23, 2006

(54) Adhesive poster board display system and method for display

(76) Inventors: Catherine H. Wescott, Beavercreek, OH (US); Thomas S. Walker, Kettering, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/943,319

(22) Filed: Sep. 17, 2004

(51) Int. Cl. G09F 7/12

(52) U.S. Cl. 40/594

(57) ABSTRACT

A display system includes a sheet-like poster board with a back surface and a display surface. An adhesive is located on the back surface of the poster board and a peelable liner is removably adhered to the adhesive. The poster board is temporarily securable to a mounting surface by removing the peelable liner to expose the adhesive and pressing the adhesive against the mounting surface.

### FIELD

The present invention is directed to a poster board display system, and more particularly, to a poster board display system having an adhesive located thereon.

### BACKGROUND

Business enterprises, individuals, schools and other organizations use poster boards as a means of communication and decoration, as well as for advertisements, presentations and artwork. Poster boards are typically used for temporary display, and therefore some structure, such as bulletin boards, may be required to display the poster boards. While bulletin boards provide a convenient method for displaying poster board, bulletin boards are not always conveniently located or available when needed. Accordingly, poster boards frequently need to be mounted on a variety of surfaces such as plaster, painted or wallpapered walls, metal lockers or cabinets, chalk or white boards.

Accordingly, a simple, easy and attractive system and method for securing a poster board to various surfaces is needed.

### SUMMARY

In one embodiment the invention is a display system which includes sheet-like poster board with a back surface and a display surface. An adhesive is located on the back surface of the poster board and a peelable liner is removably adhered to the adhesive. The poster board is temporarily securable to a mounting surface by removing the peelable liner to expose the adhesive and pressing the adhesive against the mounting surface.

In another embodiment the invention is a method for display that includes providing a sheet-like poster board having a display surface and a back surface. The back surface has an adhesive located thereon and a peelable liner removably adhered to the adhesive. The method further includes the steps of marking on the display surface and removing the peelable liner to expose the adhesive. The method further includes the step of pressing the adhesive against a mounting surface to thereby mount said poster board to the mounting surface.

### BRIEF DESCRIPTION OF THE DRAWINGS

FIG. 1A is a top view of one embodiment of the poster board;

FIG. 1B is a top view of the opposite side of the poster board of FIG. 1;

FIG. 2 is a cross-section of an adhesive strip of the poster board of FIG. 1; and

FIG. 3 is a detail perspective view of the peelable liner used with an adhesive strip of FIG. 1.

### DETAILED DESCRIPTION

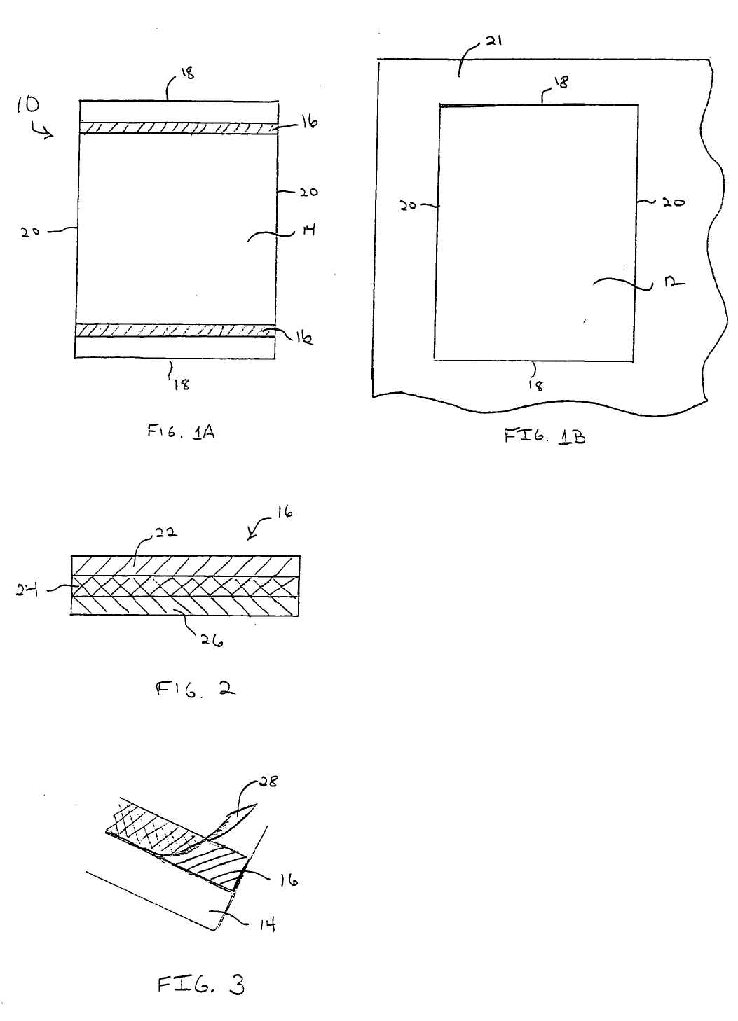

Referring to FIGS. 1A and 1B, in a one embodiment of the present invention the poster board 10 includes a display surface 12 and a back surface 14 located on an opposite side of the poster board 10. The poster board 10 can be made of a variety of materials, including paperboard, cardboard, paper, plastic, a combination of these materials or various other materials. The poster board 10 may be made of materials that allow a user to write thereon with a pen, pencil or the like, or upon which pre-printed graphics may be printed. The display surface 12 of the poster board 10 may be white, colored or multi-colored. The poster board 10 may be manufactured in multiple sizes, for example, 11 inches×14 inches, 22 inches×28 inches, or 24 inches×36 inches. However, the poster board 10 may be any size suitable for display and communication of information. In the embodiment shown in FIGS. 1A and 1B, the poster board 10 is rectangular having a pair of short outer edges 18 and a pair of long outer edges 20.

The poster board 10 may include two strips of pressure sensitive adhesive 16 pre-adhered or permanently adhered to the back surface 14 of the poster board 10 to allow the poster board 10 to be mounted to a wall or other mounting surface 21. As used herein, permanently adhered or permanent adhesive means that the under normal use the adhesive 16 has sufficient adhesive strength to remain adhered to the back surface 14 of the poster board 10, and to resist attempted manual removal. However, under certain conditions, including extreme heat or contact with certain solvents, the adhesive 16 may be able to be removed from the back surface 14. In the embodiment illustrated in FIG. 1A, the adhesive strips 16 are located proximate to, and substantially parallel with, the short outer edge 18 of the rectangular poster board 10. This configuration allows the poster board 10 to be securely mounted to a mounting surface 21. Because the adhesive is, in the illustrated embodiment, in the form of a continuous strip 16 that runs the full width of the poster board 10, when adhesive strip 16 is pressed against a mounting surface 21 the poster board 10 will lay flat against the surface without curving or bowing. In addition, a continuous strip of adhesive 16 will allow the poster board 10 to adhere more easily to uneven surfaces or surfaces that include gaps. If the poster board had only patches or discontinuous strips of adhesive, a user would need to ensure that the adhesive patch did not coincide with a gap in the mounting surface 21.

Many configurations of the adhesive are possible. For example, rather than extending along the short outer edges 18, the adhesive strips may be located along the long outer edges 20, or located along both the short outer edges 18 and the long outer edges 20. Additionally, the adhesive strips could be significantly spaced away from the outer edges 18, 20 of the poster board 10. For example, the adhesive strips could form a cross shape, extend diagonally across the back surface 14, etc. Alternatively, the entire back surface 14 may be covered in adhesive.

In the illustrated embodiment, the adhesive strips 16 are located at opposite ends of the poster board 10 and extend along the short outer edges 18. This configuration ensures that the poster board 10 lays flat against the surface to which it is mounted. While the same effect might be achieved by locating the two adhesive strips substantially parallel to the long outer edges 20 of the poster board 10, the shorter strips may be sufficient to secure the poster board 10 to most surfaces and requires less adhesive.

In one embodiment, each of the adhesive strips 16 is located proximate to or adjacent to one of the outer edges 18, 20 of the rectangular shaped poster board 10, but spaced inwardly from the associated outer edges 18, 20 (i.e., by 1-2 inches) to improve manufacturing efficiency. In particular, if the adhesive strips 16 were to be located directly on or adjacent to the outer edge of the poster board 10 more exact placement of the strips would be required which creates difficulties in manufacturing. Spacing the adhesive strips 16 an inch or two from the associated short outer edge 18 allows for slight misplacements without affecting the adhesive function, or contaminating the display surface 12 of the poster board 10 or the manufacturing equipment with adhesive. Additionally, spacing the adhesive strips 16 at a distance from the outer edge allows a user to trim the sheet of the poster board 10 slightly without affecting the adhesion. Finally, a gap between the outer edge of the poster board 10 and the adhesive strips 16 allows a user slide a finger between the poster board and the mounting surface 21 to grip the poster board 10 and remove the poster board 10 from the mounting surface 21.

Referring now to FIG. 2, each of the adhesive strips 16 may include a relatively weak or temporary adhesive 22, a barrier 24 and a relatively strong or permanent adhesive 26. The permanent adhesive 26 adheres the adhesive strip 16 to the back surface 14 of the poster board 10 in the manner outlined above. The barrier 24 prevents the permanent adhesive 26 and the temporary adhesive 22 from contaminating each other. The barrier 24 may be paper, plastics such as polyvinyl chloride, polyester film such as MYLAR®, sold by E.I. DuPont de Nemours and Company of Wilmington, Del., and other suitable materials.

The temporary adhesive 22 is intended to be adhered to the surface on which the poster board 10 is to be mounted. The temporary adhesive 22 is of sufficient strength to secure the poster board 10 to the mounting surface 21, but allows the poster board 10 to be easily removed from the surface by simply pulling on the poster board 10. The temporary adhesive 22 may have sufficient adhesive strength such that two 11 inch×1 inch strips are capable of adhering an 11 inch×14 inch piece of paperboard having a weight of about 0.9 ounces to a relatively smooth mounting surface 21, such as clean flat painted metal. The temporary adhesive 22 may have an adhesive strength between ten percent and fifty percent of the adhesive strength of the permanent adhesive 26. In one embodiment, when the poster board 10 is removed from the mounting surface 21, such as clean flat painted metal, the temporary adhesive 22 is sufficiently weak to pull away from the mounting surface 21 cleanly, leaving no adhesive on the mounting surface 21.

Referring now to FIG. 3, a peelable liner 28 may be adhered to the temporary adhesive 22 of each of the adhesive strips 16. The peelable liner 28 may be a generally peelable material such as paper with a thin plastic film or coating, such as polyethylene, polypropylene or the like. The peelable liner 28 allows the poster board 10 to be shipped or stored with the adhesive strips 16 in place and prevents the adhesive from adhering to a surface during shipping or storage.

To utilize the poster board 10, a user may first write, draw or mark on the display surface 12 of the poster board 10 using pens, markers, pencils, crayons and the like. The user may then hold the poster board 10 up against the mounting surface 21 to determine the appropriate position for the poster board 10. With the peelable liners 28 in place, the user is able to test multiple locations prior to adhering the poster board 10 to the mounting surface 21. After the appropriate position is selected, the user may remove the peelable liners 28 from the adhesive strips 16, place the poster board 10 at the appropriate position and press the adhesive strips 16 against the mounting surface 21. When the poster board 10 has served its purpose, the user may remove the poster board 10 by seizing the poster board 10 (i.e. at one of the corners) and pulling the poster board 10 away from the mounting surface 21.

In an alternate embodiment, the display surface 12 of the poster board 10 may include pre-printed graphics located thereon. For example, the display surface 12 may be pre-printed with a calendar grid, common phrases such as “For Sale,” or a common design such as party balloons. The user may add specific information such as event dates, prices or event information to the display surface 12.

The system and method described and shown herein allows a user to quickly and easily mount a poster board to a surface such as a wall, a door, a cabinet and the like. Once the poster board has served its purpose, the user may remove the poster board by simply pulling the poster board away from the mounting surface. In one embodiment, the poster board will come away from the mounting surface cleanly, without leaving adhesive on the surface.

While particular embodiments of the present invention have been illustrated and described, it would be obvious to those skilled in the art that various additional changes and modifications can be made without departing from the spirit and scope of the present invention. It is therefore intended to cover in the appended claims all such changes and modifications that are within the scope of this invention.

What is claimed is:

1. A display system comprising:
a sheet-like poster board including a back surface and a display surface;
an adhesive located on the back surface of the poster board; and
a peelable liner removably adhered to the adhesive, wherein the poster board is temporarily securable to a mounting surface by removing the peelable liner to expose the adhesive and pressing the adhesive against the mounting surface.

2. The display system of claim 1 wherein the adhesive includes a strip of adhesive extending substantially parallel to an outer edge of the poster board.

3. The display system of claim 2 wherein the poster board is substantially rectangular.

4. The display system of claim 3 wherein the adhesive includes a supplemental strip of adhesive extending generally parallel to said strip of adhesive and being located adjacent to a second outer edge of said poster board, each adhesive strip spaced inwardly from the associated outer edge.

5. The display system of claim 4 wherein the poster board has a length and a width that is shorter than said length and wherein said adhesive strip and said supplemental adhesive strip each extend generally parallel to said width.

6. The display system of claim 2 wherein the dimensions of the poster board are one of: 11 inches×14 inches, 22 inches×28 inches, 24 inches×36 inches or 8½ inches×11 inches.

7. The display system of claim 1 wherein the display surface includes preprinted graphics located thereon.

8. The display system of claim 1 wherein the display surface of the poster board is non-white.

9. The display system of claim 1 wherein the display surface includes material suitable for marking thereon with a non-permanent ink marking device.

10. The display system of claim 1 wherein the poster board is paperboard.

11. The display system of claim 1 wherein the adhesive has a first side adhered to said back surface and a second side adhered to said peelable liner, wherein an adhesive strength of said first side is greater than an adhesive strength of said second side.

12. The display system of claim 11 wherein the adhesive strength of said temporary adhesive to a substrate is between about 10% and about 50% of the strength of said permanent adhesive to said substrate.

13. The display system of claim 1 wherein the adhesive includes:
a permanent adhesive adhered to said back surface;
a barrier adhered to the permanent adhesive; and
a temporary adhesive adhered to said barrier and said peelable liner, wherein an adhesive strength of said permanent adhesive is greater than an adhesive strength of said temporary adhesive.

14. A display system comprising:
a substantially rectangular sheet-like poster board including a back surface and a display surface;
a first and a second adhesive strip located on the back surface of the poster board, each adhesive strip being oriented substantially parallel to a first edge of the poster board; and
a first and a second peelable liner removably adhered to the first and the second adhesive strips, respectively, wherein the poster board is temporarily securable to a mounting surface by removing the first and the second peelable liner to expose the first and the second adhesive strips, respectively, and pressing the first and second adhesive strip against the mounting surface.

15. The display system of claim 14 wherein the first adhesive strip is proximate to the first edge of the poster board and the second adhesive strip is proximate to a second edge of the poster board that is oriented on an opposite said of said poster board relative to said first edge.

16. The display system of claim 14 wherein the first and the second adhesive strip each includes:
a permanent adhesive adhered to said back surface;
a barrier adhered to the permanent adhesive; and
a temporary adhesive adhered to said barrier and said peelable liner, wherein an adhesive strength of said permanent adhesive is greater than an adhesive strength of said temporary adhesive.

17. A method for display comprising the steps of:
providing a sheet-like poster board having a display surface, a back surface, an adhesive located on said back surface and a peelable liner removably adhered to the adhesive;
marking on said display surface;
removing said peelable liner to expose said adhesive; and
pressing the adhesive against a mounting surface to thereby mount said poster board to said mounting surface.

18. The method of claim 17 wherein said marking step is performed manually.

19. A display system comprising:
a sheet-like poster board including a back surface and a display surface; and
an adhesive adhesively coupled to said back surface of the poster board with a first adhesive strength, and wherein an opposite surface of said adhesive has a second adhesive strength that is weaker that said first adhesive strength.

20. The system of claim 19 wherein the second adhesive strength is between about 10% and about 50% of the strength of said first adhesive strength.
